(19) United States
(12) Patent Application Publication
(10) Pub. No.: US 2025/0377610 A1
(43) Pub. Date: Dec. 11, 2025

(54) IMAGE FORMING APPARATUS

(71) Applicant: SHARP KABUSHIKI KAISHI, Sakai City (JP)

(72) Inventor: KAZUTAKA MATSUMOTO, Sakai City (JP)

(21) Appl. No.: 19/202,332

(22) Filed: May 8, 2025

(30) Foreign Application Priority Data
Jun. 6, 2024 (JP) 2024-092428

(51) Int. Cl. G03G 15/043; G03G 15/04

(52) U.S. Cl. CPC G03G 15/043; G03G 15/04072; G03G 15/0409; G03G 2215/0404

(57) ABSTRACT

This disclosure provides an image forming apparatus that adjusts density of a virtual latent-image line by causing a laser corrector to correct a plurality of laser beams. The image forming apparatus controls an exposure section and causes a scanning region of a photoreceptor to be irradiated with the plurality of laser beams in a main-scanning direction to form a real latent-image line, determines whether or not a virtual latent-image line is formed between the two real latent-image lines adjacent to each other in a sub-scanning direction, and causes a laser corrector to correct a plurality of laser beams on the basis of the determination result to adjust density of a virtual latent-image line.

### CROSS-REFERENCE TO RELATED APPLICATIONS

The present application claims priority from Japanese Application JP2024-092428, the content to which is hereby incorporated by reference in to this publication.

### BACKGROUND OF THE INVENTION

### Field of the Invention

This disclosure relates to an image forming apparatus, and more particularly, to an image forming apparatus including an optical scanning device that scans a photoreceptor with multiple beams emitted from a plurality of laser light sources.

### Description of the Background Art

Conventionally, in an image forming apparatus, an interleave scanning method has been adopted as means to achieve pseudo high-resolution in a sub-scanning direction. In the interleave scanning method, when a laser beam is physically scanned at a real latent-image line position, an electrostatic latent image is formed at a virtual latent-image line position without physically scanning the laser beam at the virtual latent-image line position between two pieces of real latent-image line positions.

In addition, by adjusting a light amount (intensity or irradiation time) of the laser beam at the real latent-image line position, a toner image can be made to be developed at the virtual latent-image line position without developing the toner image at the real latent-image line position.

However, when gradation expression is performed by an area gradation method, an image pattern expressing each gradation level is formed by various dot patterns and thus, even when density adjustment is performed with a line image, there was a possibility that an accurate density (accurate gradation level) cannot be acquired depending on the dot pattern.

In order to solve the problem as above, there has been proposed an image forming apparatus of an interleave scanning method in which an image pattern including both dots at real latent-image line positions and dots at virtual latent-image line positions is formed in a reference image pattern for adjustment of light intensity or irradiation time, and density adjustment is performed.

In addition, due to face tangle error of a polygon mirror in an exposure device, periodic jitter may occur in a scanning position of the laser beam, and a pitch between the scanning positions may vary. When the pitch between the scanning positions varies, density unevenness or color shift in the sub-scanning direction occurs.

In order to solve the problem as above, there has been proposed an image forming apparatus of an interleave scanning type in which a light amount correction value is varied in accordance with a pitch.

### SUMMARY OF THE INVENTION

Incidentally, in an image forming apparatus using multiple beams, a phenomenon called reciprocal law failure in which a region across scanning becomes dense is known. However, since an art of the conventional image forming apparatus of the interleave scanning method does not take the reciprocal law failure into consideration, there is a possibility that the dot formation in the region across scanning of the polygon mirror becomes thicker and denser as compared with the dot formation not in the region across scanning.

This disclosure was made in view of the circumstances as described above, and an object of this disclosure is to provide an image forming apparatus that is less likely to be affected by reciprocal law failure than before when pseudo high-resolution processing is executed in the sub-scanning direction.

This disclosure is to provide an image forming apparatus characterized by including: an image-data acquirer that acquires image data; a photoreceptor; a charger that charges the photoreceptor; an exposure section that forms an electrostatic latent image on the photoreceptor in a charged state; a developer that supplies a toner to the photoreceptor and forms a toner image corresponding to the electrostatic latent image; a transferer that transfers the toner image to a print sheet; an image former including a fixer that heats and fixes the toner image to the print sheet; and one or more controllers that control the image-data acquirer, the photoreceptor, the charger, the exposure section, the developer, the transferer and the image former, the exposure section including: a plurality of laser light-sources that emit a plurality of laser beams; a polygon mirror that deflects the plurality of laser beams by a plurality of mirror surfaces and emits the same to a scanning region of the photoreceptor; a laser driver that forms the electrostatic latent image by irradiating the scanning region of the photoreceptor in the charged state with the plurality of laser beams on the basis of the image data acquired by the image-data acquirer; and a laser corrector that corrects the laser beam, in which the one or more controllers control the exposure section to form a real latent-image line by irradiating the scanning region of the photoreceptor with the plurality of laser beams in a main-scanning direction, determines whether or not a virtual latent-image line is formed between two pieces of the real latent-image lines adjacent to each other in a sub-scanning direction, and causes the laser corrector to correct the plurality of laser beams and adjusts density of the virtual latent-image line on the basis of the determination result.

According to this disclosure, when the pseudo high-resolution processing in the sub-scanning direction is to be executed, an image forming apparatus, which is less likely to be affected by reciprocal law failure than before can be realized by determining whether or not a virtual latent-image line is formed between two real latent-image lines adjacent to each other in the sub-scanning direction and by adjusting the density of the virtual latent-image line by causing the laser corrector to correct the plurality of laser beams on the basis of the determination result.

### BRIEF DESCRIPTION OF THE DRAWINGS

FIG. 1 is a perspective view illustrating an appearance of a digital multifunction machine according to Embodiment 1 of this disclosure.

FIG. 2 is a sectional diagram illustrating a schematic configuration of the digital multifunction machine according to Embodiment 1 of this disclosure.

FIG. 3 is a block diagram illustrating a schematic configuration of the digital multifunction machine illustrated in FIG. 1.

FIG. 4 is an explanatory diagram illustrating a schematic configuration of a laser-writing unit of an image reader of the digital multifunction machine illustrated in FIG. 1.

FIG. 5 is a block diagram illustrating an example of a configuration according to laser correction processing of the digital multifunction machine illustrated in FIG. 1.

FIGS. 6A and 6B are explanatory diagrams illustrating examples of a real latent-image line and a virtual latent-image line adjacent thereto of image data of the digital multifunction machine illustrated in FIG. 1 and setting examples of the correction thereof.

FIG. 6A illustrates a setting example of correction in a case where there is no region across scanning and FIG. 6B illustrates a setting example of the correction in a case where there is a region across scanning.

FIG. 7 is a table illustrating an example of a relationship between a peripheral status of dots in a real latent image of image data and correction setting of the digital multifunction machine illustrated in FIG. 1.

FIG. 8 is a flowchart illustrating an example of laser correction processing of the digital multifunction machine illustrated in FIG. 1.

FIGS. 9A and 9B are explanatory diagrams illustrating an example of a real latent-image line and a virtual latent-image line adjacent thereto of image data of the digital multifunction machine according to Embodiment 2 of this disclosure and a setting example of the correction.

FIG. 9A illustrates a setting example of correction in a case where there is no region across scanning and FIG. 9B illustrates a setting example of the correction in a case where there is a region across scanning.

FIG. 10 is a flowchart illustrating an example of laser correction processing of the digital multifunction machine according to Embodiment 2 of this disclosure.

FIGS. 11A and 11B are explanatory diagrams illustrating an example of a real latent-image line and a virtual latent-image line adjacent thereto of image data of the digital multifunction machine according to Embodiment 3 of this disclosure and a setting example of the correction.

FIG. 11A illustrates a setting example of correction in a case where there is no region across scanning and FIG. 11B illustrates a setting example of the correction in a case where there is a region across scanning.

FIG. 12 is a flowchart illustrating an example of laser correction processing of the digital multifunction machine according to Embodiment 3 of this disclosure.

### DESCRIPTION OF THE PREFERRED EMBODIMENTS

In this disclosure, an “image forming apparatus” is, for example, an apparatus that forms and outputs an image, such as a copying machine having a copying (copy) function, including a printer that uses an electrophotographic format for image formation with a toner, or a Multifunction Peripheral (MFP) that includes also functions other than copying.

The “image-data acquirer” of this disclosure is realized by an image reader 111 in Embodiment 1, which will be described later.

In addition, the “photoreceptor” of this disclosure is realized by a photosensitive drum 13.

In addition, a “charger” of this disclosure is realized by a charger 15.

In addition, an “exposure section” of this disclosure is realized by an optical scanning device 11.

In addition, a “developer” of this disclosure is realized by a developing device 12.

In addition, a “transferer” of this disclosure is realized by an intermediate transfer belt 21.

Furthermore, preferred embodiments of this disclosure will be explained.

In the image forming apparatus according to this disclosure, when a virtual latent-image line is formed, the one or more controllers may determine whether or not the virtual latent-image line is formed in a region across scanning between a scanning region of the photoreceptor by the mirror surface of the polygon mirror and a scanning region of the photoreceptor by the subsequent mirror surface, and when the virtual latent-image line is formed in the region across scanning, the one or more controllers may cause the laser corrector to correct the plurality of laser beams so as to lower the density of the virtual latent-image line than the case where the virtual latent-image line is formed without changing the mirror surface of the polygon mirror.

As described above, when the pseudo high-resolution processing in the sub-scanning direction is to be executed, in a case where the virtual latent-image line is formed, it is determined whether or not the virtual latent-image line is formed in the region across scanning between the scanning region of the photoreceptor by one mirror surface of the polygon mirror and the scanning region of the photoreceptor by the subsequent mirror surface. And when the virtual latent-image line is formed in the region across scanning, the laser corrector is caused to correct the plurality of laser beams so that the density of the virtual latent-image line is made lower than the case where the virtual latent-image line is formed without changing the mirror surface of the polygon mirror. In this way, it is possible to realize an image forming apparatus that is less likely to be affected by reciprocal law failure than before.

In the image forming apparatus according to this disclosure, when the virtual latent-image line is formed in the region across scanning, the one or more controllers may determine whether or not the real latent-image line is formed at a real latent-image position adjacent to the virtual latent-image line, and when the real latent-image line is formed at the real latent-image position, the laser corrector may be caused to correct the plurality of laser beams such that the density of the virtual latent-image line is made lower than the case where the real latent-image line is not formed at the real latent-image position.

As described above, in a case where the virtual latent-image line is formed in the region across scanning, it is determined whether or not the real latent-image line is formed at the real latent-image position adjacent to the virtual latent-image line. And when the real latent-image line is formed at the real latent-image position, the laser corrector is caused to correct the plurality of laser beams so that the density of the virtual latent-image line is made lower than the case where the real latent-image line is not formed at the real latent-image position. In this way, it is possible to realize an image forming apparatus that is less likely to be affected by reciprocal law failure than before.

In the image forming apparatus according to this disclosure, the laser corrector may adjust the density of the virtual latent-image line by correcting at least one of a PWM DUTY ratio of the plurality of laser beams, bias currents of the plurality of laser light sources, and light amounts of the plurality of laser beams.

As described above, when the pseudo high-resolution processing in the sub-scanning direction is to be executed, it is determined whether or not a virtual latent-image line is formed between two pieces of the real latent-image lines adjacent to each other in the sub-scanning direction. And on the basis of the determination result, the laser corrector is caused to correct the PWM DUTY ratios of the plurality of laser beams, the bias currents of the plurality of laser light sources, and the laser-beam amounts of the plurality of laser beams so as to appropriately adjust the density of the virtual latent-image line. In this way, it is possible to realize an image forming apparatus that is less likely to be affected by reciprocal law failure than before.

Hereinafter, this disclosure will be described in more detail with reference to the drawings. Note that the following explanation is exemplification in all respects and should not be construed as limiting this disclosure.

### Embodiment 1

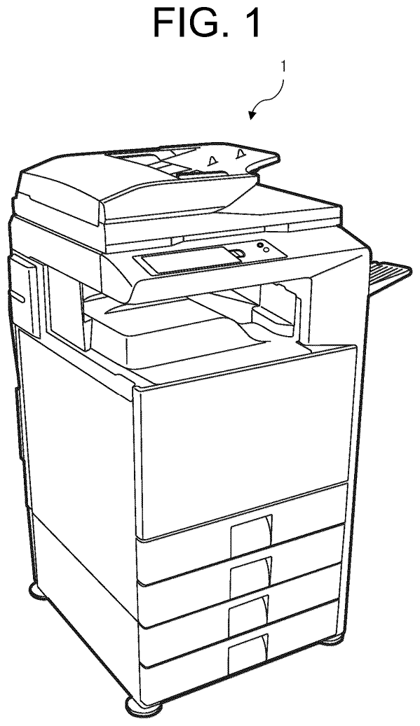

A schematic configuration of a digital multifunction machine 1 that is one embodiment of an image reader of this disclosure will be explained on the basis of FIGS. 1 to 4.

FIG. 1 is a perspective view illustrating an appearance of the digital multifunction machine 1 according to Embodiment 1 of this disclosure.

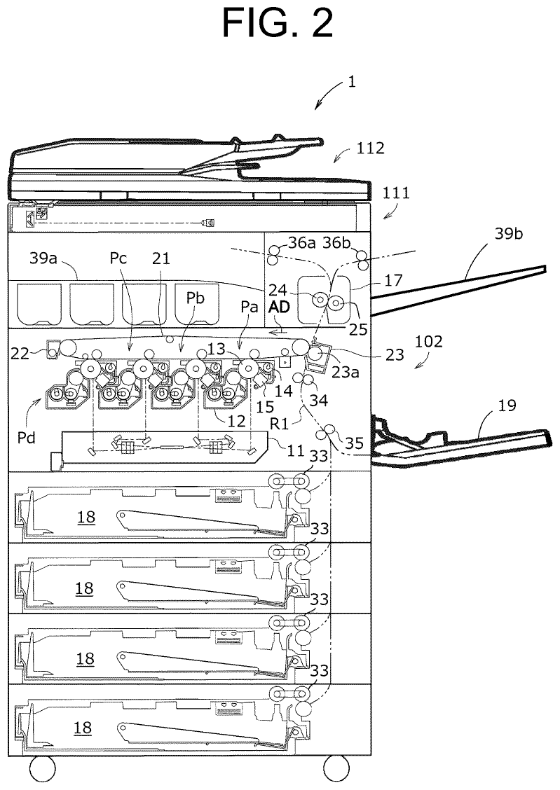

FIG. 2 is a sectional diagram illustrating a mechanism configuration of a main body of the digital multifunction machine 1 illustrated in FIG. 1.

The digital multifunction machine 1 is an apparatus such as a multifunction machine or an MFP, which digitally processes image data and has a copying function, a scanner function, and a facsimile function.

The digital multifunction machine 1 executes jobs of scanning, printing, and copying on the basis of an instruction from a user received via an operation acceptor 103 or a communicator 55.

### Configuration of Digital Multifunction Machine 1

Here, an internal configuration of the digital multifunction machine 1 shown in FIG. 2 will be explained in brief.

The digital multifunction machine 1 prints a color image using each color of black (K), cyan (C), magenta (M), and yellow (Y) on a print sheet.

Thus, as the internal configuration of the digital multifunction machine 1, four each of developing devices 12, photosensitive drums 13, drum cleaning devices 14, chargers 15 and the like are provided.

In order to form four types of toner images corresponding to the respective colors, four image stations Pa, Pb, Pc, and Pd are constituted in the digital multifunction machine 1 correspondingly to black, cyan, magenta, and yellow, respectively.

Note that the digital multifunction machine 1 may print a monochrome image using a single color (black, for example) on a print sheet.

In each of the image stations Pa, Pb, Pc, and Pd, a toner image is formed as follows.

The drum cleaning device 14 removes and collects residual toner on the surface of the photosensitive drum 13.

Thereafter, the charger 15 uniformly charges the surface of the photosensitive drum 13 to a predetermined potential.

Subsequently, the optical scanning device 11 exposes the uniformly-charged surface and forms an electrostatic latent image on the surface.

Thereafter, the developing device 12 develops the electrostatic latent image.

In this way, the toner image in each color is formed on the surface of the respective photosensitive drum 13.

In addition, the intermediate transfer belt 21 circularly moves in an arrow direction AD.

The toner image in each color on the surface of each of the photosensitive drums 13 is sequentially transferred and superimposed onto the intermediate transfer belt 21, and the color toner image is formed on the intermediate transfer belt 21.

A belt cleaning device 22 removes and collects the residual toner on the circularly moving intermediate transfer belt 21.

The print sheet is picked up from one of four feed trays 18 by a pickup roller 33 and is fed to a secondary transfer device 23 via a sheet conveyance path R1.

Alternatively, the print sheet is fed from a manual feed tray 19 by the pickup roller, not shown, and is fed to the secondary transfer device 23 via the sheet conveyance path R1.

A resist roller 34 that temporarily stops the print sheet and aligns leading edges of the print sheets is disposed in the sheet conveyance path R1.

In addition, a conveyance roller 35 that promotes conveyance of the print sheet and the like are disposed.

A nip region is formed between a transfer roller 23a of the secondary transfer device 23 and the intermediate transfer belt 21.

After stopping the print sheet once, the resist roller 34 conveys the print sheet to the nip region at the transfer timing of the toner image.

When the print sheet passes through the nip region, the color toner image formed on the surface of the intermediate transfer belt 21 is transferred onto the print sheet.

After passing through the nip region, the print sheet is sandwiched between a heating roller 24 and a pressure roller 25 of the fixing device 17 to be heated and pressurized.

With the heating and pressurization, the color toner image is fixed onto the print sheet.

Subsequently, the print sheet that has passed through the fixing device 17 is discharged to a discharge tray 39a or 39b via a discharge roller 36a or 36b.

A discharge destination of the print sheet is controlled by a controller 100, which will be described later, and the conveyance path is switched by a switching mechanism, not shown, so that the print sheet is guided to either one of the discharge trays 39a and 39b.

Since the switching mechanism of the conveyance path of the print sheet is well-known in the technical field of the image forming apparatus, detailed illustration thereof is omitted.

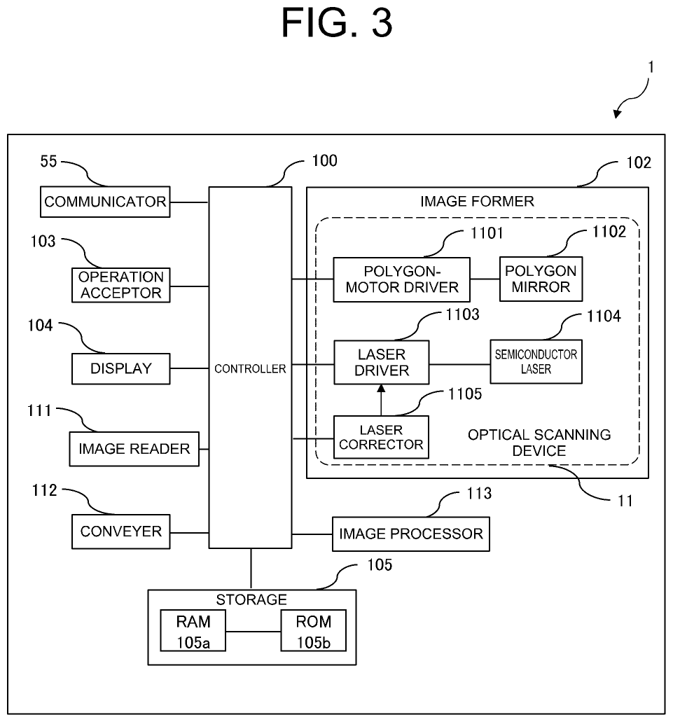

Subsequently, an electrical configuration of the digital multifunction machine 1 will be explained in brief with reference to FIG. 3.

FIG. 3 is a block diagram illustrating the electrical configuration of the digital multifunction machine 1 shown in FIG. 1.

As shown in FIG. 3, the digital multifunction machine 1 includes the communicator 55, the controller 100, an image former 102, the operation acceptor 103, a display 104, a storage 105, the image reader 111, a conveyer 112, and an image processor 113.

The communicator 55 is a circuit and firmware of a communication interface that transmits and receives communication data to and from an external device and receives an execution instruction of a print job from an external computer, for example.

The controller 100 comprehensively controls the digital multifunction machine 1 and includes one or more Central Processing Units (CPU), one or more Random Access Memories (RAM), one or more Read Only Memories (ROM), various types of interface circuits and the like.

The controller 100 monitors and controls various loads such as detection of each sensor, a motor, a clutch, a fixing lamp and the like in order to control the entire operation of the digital multifunction machine 1.

Note that FIG. 3 is an example of the configuration, and the configuration may include a plurality of controllers 100 and substrates so as to control the operation of the digital multifunction machine 1.

The image former 102 prints a print image on a print sheet by an electrophotographic format. The image former 102 includes electrical constituent elements related to the optical scanning device 11, the developing device 12, the photosensitive drum 13, the drum cleaning device 14, and the charger 15, which are illustrated in FIG. 2.

In addition, the image former 102 further includes electrical constituent elements related to the intermediate transfer belt 21, the fixing device 17, the sheet conveyance path R1, the feed tray 18, the manual feed tray 19, and the discharge trays 39a, 39b.

Furthermore, the image former 102 includes a polygon-motor driver 1101, a polygon mirror 1102, a laser driver 1103, a semiconductor laser 1104, and a laser corrector 1105.

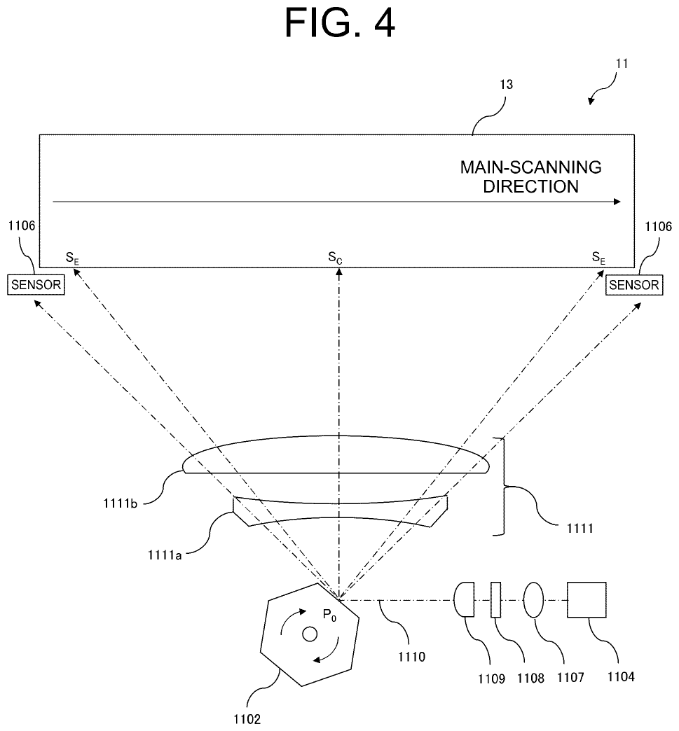

Note that the other constituent elements of the optical scanning device 11 will be described later in the explanation of FIG. 4.

The polygon-motor driver 1101 is a part that drives a polygon motor to rotate the polygon mirror 1102 at a constant angular speed.

The polygon mirror 1102 is a rotary polygon mirror that has a polygonal prism shape such as a hexagonal prism or an octagonal prism, includes a mirror on a side surface, and rotates around a center axis of the polygonal prism. The polygon mirror 1102 usually rotates approximately 20000 to 30000 times per minute.

A plurality of laser beams emitted from the semiconductor laser 1104 are reflected by the polygon mirror 1102 and deflected to the photosensitive drum 13.

The semiconductor laser 1104 forms an electrostatic latent image by irradiating the scanning surface of the photosensitive drum 13 with a laser beam.

The laser driver 1103 is a part that controls the light-emission timing of the semiconductor laser 1104.

The laser driver 1103 converts the scanning speed of the laser beam reflected by the reflection surface of the polygon mirror 1102 from a constant angular speed to a constant speed.

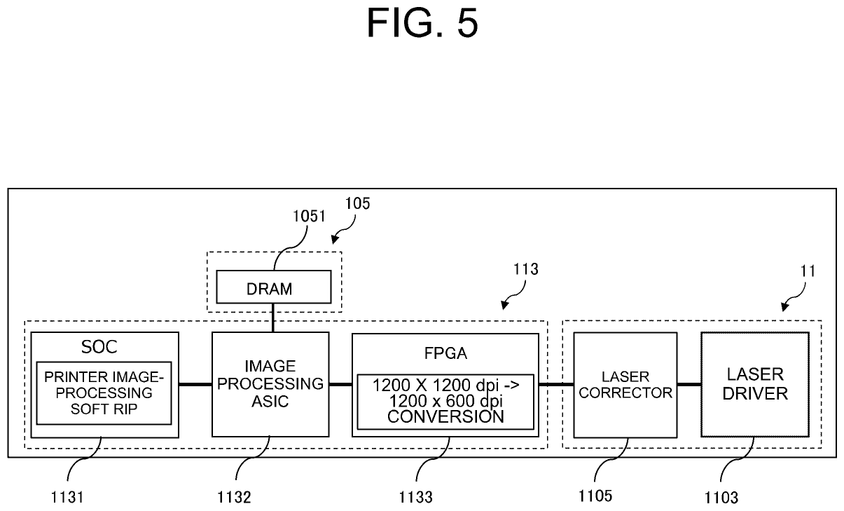

The laser corrector 1105 is a part that corrects the PWM DUTY ratio and the like of the laser beam of the semiconductor laser 1104. Note that details of the correction of the laser beam by the laser corrector 1105 will be described later in the explanation of FIGS. 5 to 8.

The operation acceptor 103 is a part constituted by a liquid crystal display and a touch panel, displays information on the liquid crystal display, and receives an instruction from a user via the touch panel.

The display 104 is a part that displays various kinds of information.

The display 104 is, for example, constituted by a CRT display, a liquid crystal display, an EL display or the like and is a display device such as a monitor or a line display for an operating system or application software to display electronic data such as a processing state or the like. The controller 100 displays the operation and a state of the digital multifunction machine 1 via the display 104.

The storage 105 is an element or a storage medium that stores information required for realizing various functions of the digital multifunction machine 1, a control program and the like, and includes one or more RAM 105a and one or more ROM 105b. For example, a storage medium such as one or more hard disk device (HDD), one or more flash storage, one or more SSD (Solid State Drive) or the like is used, and various types of data and programs are stored.

The RAM 105a is a storage that can be accessed by the controller 100 and provides a work storage that temporarily stores data.

In the RAM 105a, for example, electrostatic capacity threshold values of the touch panel and a database of various kinds of images are recorded.

The ROM 105b is a read-only storage that can be accessed by the controller 100 and stores data required for program control of the controller 100.

In the ROM 105b, for example, various kinds of data used as a basis for setting an image reading function, a touch panel function and the like are stored.

The RAM 105a and the ROM 105b are connected to the controller 100 via a bus and store a program that operates the controller 100, extend the data to the storage and the like.

The image reader 111 is a part that detects and optically reads a manuscript placed on a manuscript table or a manuscript conveyed from a manuscript tray, and generates image data.

The conveyer 112 is a part that conveys a manuscript set on a manuscript table, an Automatic Document Feeder (ADF) and a predetermined tray to the image reader 111.

The image processor 113 is a part that converts image data read from a manuscript by the image reader 111 into an appropriate electric signal on the basis of a job instruction such as printing input from the operation acceptor 103 and executes processing so as to be suitable for an output such as enlargement/reduction.

The controller 100 controls the conveyer 112 to convey the manuscript.

Then, the controller 100 controls the image reader 111 to read the image of the manuscript, controls the image processor 113 to process the image, and stores the image data indicating the image of the manuscript in the storage 105.

In addition, the controller 100 controls the image former 102 to cause a manuscript image based on the image data stored in the storage 105 to be printed on a print sheet.

### Configuration of Laser Writing Unit of Image Reader 111

Subsequently, the configuration of the laser writing unit of the image reader 111 of the digital multifunction machine 1 will be explained with reference to FIG. 4.

FIG. 4 is an explanatory diagram illustrating a schematic configuration of the laser writing unit of the image reader 111 of the digital multifunction machine 1 illustrated in FIG. 1.

A lateral axis of FIG. 4 indicates the axial direction (main-scanning direction) of the photosensitive drum 13.

As shown in FIG. 4, the laser writing unit includes a sensor 1106, the semiconductor laser 1104, a collimator lens 1107, an aperture 1108, a cylindrical lens 1109, the polygon mirror 1102, and an ft lens 1111.

The sensor 1106 is a sensor for detecting a writing start position in the main-scanning direction of the laser beam on the scanning surface of the photosensitive drum 13.

Although only one semiconductor laser 1104 is illustrated in FIG. 4, two light fluxes (multiple beams) are actually emitted from a plurality of semiconductor lasers 1104a and 1104b, and there are two light fluxes parallel to a one-dot chain line in FIG. 4.

When the laser beam starts scanning in the main-scanning direction, the sensor 1106 detects the laser beam.

At this time, when the sensor 1106 detects the writing start of the laser beam, the controller 100 drives the laser driver 1103 to cause the laser beam to be emitted.

The collimator lens 1107 is a lens that adjusts a position of a focal point of the laser beam emitted from the semiconductor laser 1104 and converts it into a parallel light beam.

The aperture 1108 passes only a part of the parallel light that has passed through the collimator lens 1107, thereby shaping the parallel light and adjusting the light amount.

The cylindrical lens 1109 converges the laser beam in a direction corresponding to the sub-scanning direction and forms a linear image. Then, deviation of a dot pitch in the sub-scanning direction of the scanning surface of the photosensitive drum 13 caused by an inclination error (face tangle error) of the reflection surface due to a machining error of the mirror surface of the polygon mirror 1102, inclination of a rotation shaft of the polygon motor, or the like is corrected.

The fθ lens 1111 is constituted by a spherical lens 1111a and a toroidal lens 1111b having a toric surface. The ft lens 1111 adjusts the focal length so that the laser beam reflected by the reflecting surface of the polygon mirror 1102 forms an image on the scanning surface of the photosensitive drum 13 and converts the scanning speed of the laser beam from a constant angular speed to a constant speed.

In addition, the toroidal lens 1111b corrects the face tangle error of the polygon mirror 1102 in cooperation with the cylindrical lens 1109.

As shown in FIG. 4, the laser beam emitted from the semiconductor laser 1104 passes through the collimator lens 1107, the aperture 1108, and the cylindrical lens 1109, respectively, along an optical path 1110. Thereafter, the laser beam is reflected by a mirror surface on a side surface of the polygon mirror 1102 and scans the scanning surface of the photosensitive drum 13 in the main-scanning direction through the fθ lens 1111, thereby forming dot-like electrostatic latent images at an equal pitch.

Note that, after the scanning for one line is completed, the controller 100 repeats the similar processing for the subsequent scanning line in the sub-scanning direction.

As described at the beginning, conventionally, in a multibeam scanning system using a plurality of light sources, a phenomenon called reciprocal law failure in which a region across scanning becomes dense is known. That is, there is a problem that formation of dots in the region across scanning between the scanning region by one mirror surface of the polygon mirror 1102 and the scanning region by the subsequent mirror surface becomes thicker and denser than the formation of dots not in the region across scanning (that is, in the scanning region in the case where the mirror surface of the polygon mirror is not changed).

Laser Correction Processing of Digital Multifunction Machine 1 according to Embodiment 1 of This Disclosure

Subsequently, laser correction processing of the digital multifunction machine 1 according to Embodiment 1 of this disclosure will be explained with reference to FIGS. 5 to 8.

FIG. 5 is a block diagram 8 illustrating an example of a configuration related to the laser correction processing of the digital multifunction machine 1 shown in FIG. 1.

When the digital multifunction machine 1 executes image processing, a software Raster Image Processor (RIP) 1131 mounted on a System on Chip (SoC) executes processing for converting vector data such as character/image data and the like into raster data (bitmap image).

In addition, image processing of the raster data after RIP is executed using the ASIC 1132 for image processing of the image processor 113 and the DRAM 1051 of the storage 105.

Thereafter, the raster data is converted (down-converted) from 1200×1200 dpi to 1200×600 dpi by a Field Programmable Gate Array (FPGA) 1133.

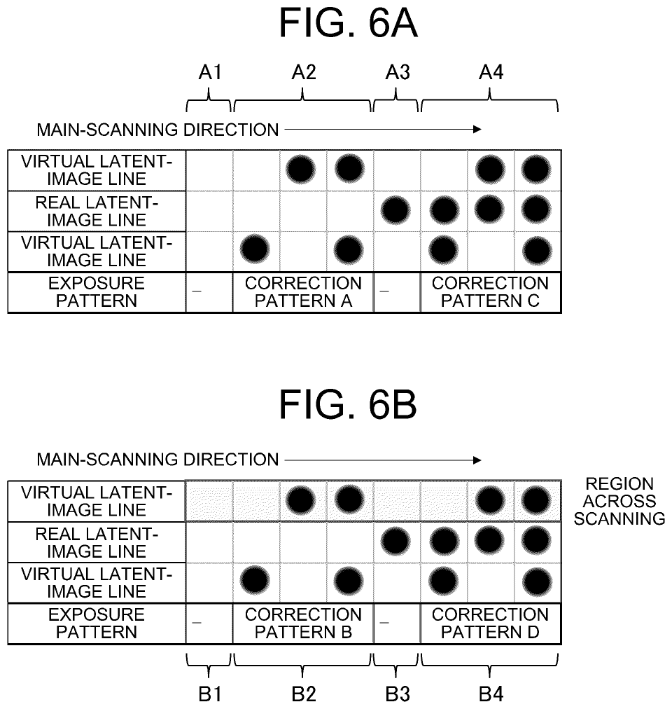

FIGS. 6A and 6B are explanatory diagrams illustrating an example of a real latent-image line and a virtual latent-image line adjacent thereto of image data of the digital multifunction machine 1 shown in FIG. 1, and an example of a correction pattern thereof.

FIG. 6A illustrates a setting example of correction in a case where there is no region across scanning and FIG. 6B illustrates a setting example of correction in a case where there is a region across scanning.

As shown in FIGS. 6A and 6B, the FPGA 1133 outputs a multi-bit 1 dot while simultaneously reading a real latent-image line and two virtual latent-image lines adjacent thereto of the image data.

Note that, as shown in FIG. 6A and FIG. 6B, setting of correction varies depending on the presence or absence of the region across scanning.

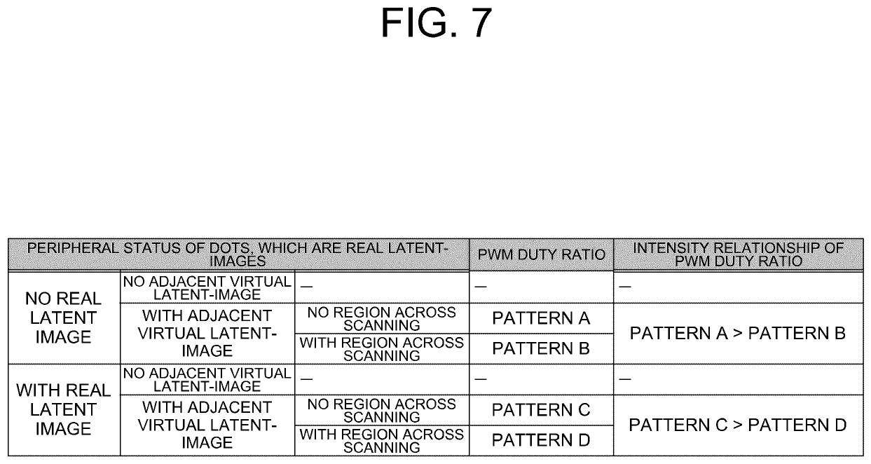

FIG. 7 is a table illustrating an example of a relationship between a peripheral state of dots to be real latent images of image data and correction setting of the digital multifunction machine 1 shown in FIG. 1.

As shown in FIG. 7, the correction setting is determined as follows in accordance with the surrounding conditions of the dots that are formed as real latent images.
(1) In the case of “no real latent images” and “no adjacent virtual latent images”, since there are not dot patterns to be exposed as shown in A1 of FIG. 6A and B1 of FIG. 6B, correction is not made.
(2) In the case of “with real latent images” and “no adjacent virtual latent images”, correction is not made, since the dots to be exposed are only real latent images as shown in A3 of FIG. 6A and B3 of FIG. 6B.
(3) In the case of “no real latent images” and “with adjacent virtual latent images”, as shown in A2 of FIG. 6A, correction is made as a correction pattern A in the case of “no region across scanning”. On the other hand, as shown in B2 of FIG. 6B, in the case of “with region across scanning”, correction is made as a correction pattern B.

Here, a difference between the correction patterns A and B is, for example, a difference in the PWM DUTY ratio, and the PWM DUTY ratio of the correction pattern A is set to be larger than the PWM DUTY ratio of the correction pattern B.

In addition, the PWM DUTY ratio of the correction pattern A is set to be smaller than the PWM DUTY ratio of the correction pattern C, and the PWM DUTY ratio of the correction pattern B is set to be smaller than the PWM DUTY ratio of the correction pattern D.
(4) In the case of “with real latent images” and “with adjacent virtual latent images”, as shown in A4 of FIG. 6A, correction is made as the correction pattern C in the case of “no region across scanning”. On the other hand, as shown in B4 of FIG. 6B, in the case of “with region across scanning”, correction is made as the correction pattern D.

Then, as shown in FIG. 5, after the laser corrector 1105 of the optical scanning device 11 of the image former 102 performs the DUTY correction on the image data subjected to the multi-bit processing, the controller 100 causes the laser driver 1103 to drive the semiconductor laser 1104 to output a laser beam on the basis of the corrected data.

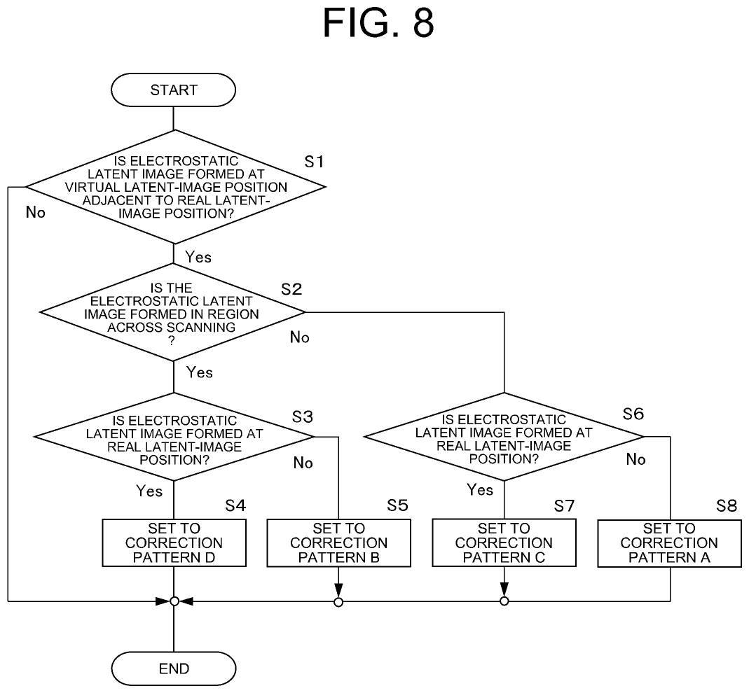

FIG. 8 is a flowchart illustrating an example of the laser correction processing of the digital multifunction machine 1 shown in FIG. 1.

At Step S1 of FIG. 8, the controller 100 of the digital multifunction machine 1 determines whether or not electrostatic latent image is formed at the virtual latent-image position adjacent to the real latent-image position (Step S1).

On the basis of the signal of the sensor 1106 and the image data transmitted from the image processor 113, the controller 100 determines whether the line is a real latent-image line or a virtual latent-image line.

When the electrostatic latent image is not formed at the virtual latent-image position adjacent to the real latent-image position (in a case where the determination at Step S1 is No), the controller 100 ends the processing, since there is no need for the correction.

On the other hand, when electrostatic latent image is formed at the virtual latent-image position adjacent to the real latent-image position (in a case where the determination at Step S1 is Yes), at Step S2, the controller 100 determines whether or not the electrostatic latent image is formed in the region across scanning (Step S2).

When the electrostatic latent image is formed in the region across scanning (in a case where the determination at Step S2 is Yes), at Step S3, the controller 100 determines whether or not the electrostatic latent image is formed at the real latent-image position (Step S3).

When the electrostatic latent image is formed at the real latent-image position (in a case where the determination at Step S3 is Yes), at Step S4, the controller 100 sets the PWM DUTY ratio to the correction pattern D (Step S4) and ends the processing.

On the other hand, when the electrostatic latent image is not formed at the real latent-image position (in a case where the determination at Step S3 is No), at Step S5, the controller 100 sets the PWM DUTY ratio to the correction pattern B (Step S5), and ends the processing.

Subsequently, at Step S2, when the electrostatic latent image is not formed in the region across scanning (in a case where the determination at Step S2 is No), at Step S6, the controller 100 determines whether or not the electrostatic latent image is formed at the real latent-image position (Step S6).

When the electrostatic latent image is formed at the real latent-image position (in a case where the determination at Step S6 is Yes), at Step S7, the controller 100 sets the PWM DUTY ratio to the correction pattern C (Step S7) and ends the processing.

On the other hand, when the electrostatic latent image is not formed at the real latent-image position (in a case where the determination at Step S6 is No), at Step S8, the controller 100 sets the PWM DUTY ratio to the correction pattern A (Step S8) and ends the processing.

As described above, when the pseudo high-resolution processing in the sub-scanning direction is executed, it is determined whether or not a virtual latent-image line is formed between two real latent-image lines adjacent to each other in the sub-scanning direction, and on the basis of the determination result, the laser corrector 1105 is caused to correct the PWM DUTY ratio of a plurality of laser beams to appropriately adjust the density of the virtual latent-image line so that the digital multifunction machine 1 less likely to be affected by reciprocal law failure than before can be realized.

### Embodiment 2

Laser Correction Processing of Digital Multifunction Machine 1 According to Embodiment 2 of this Disclosure

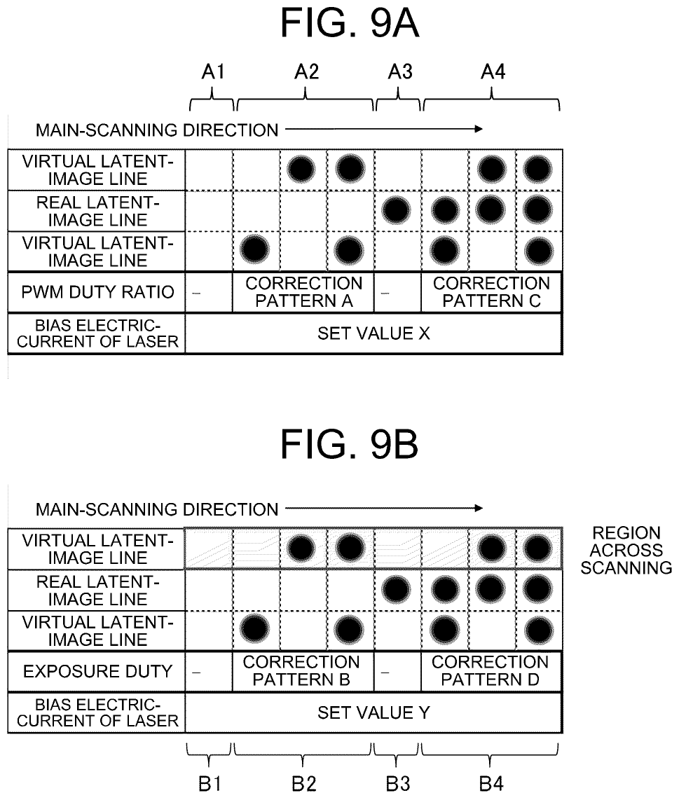

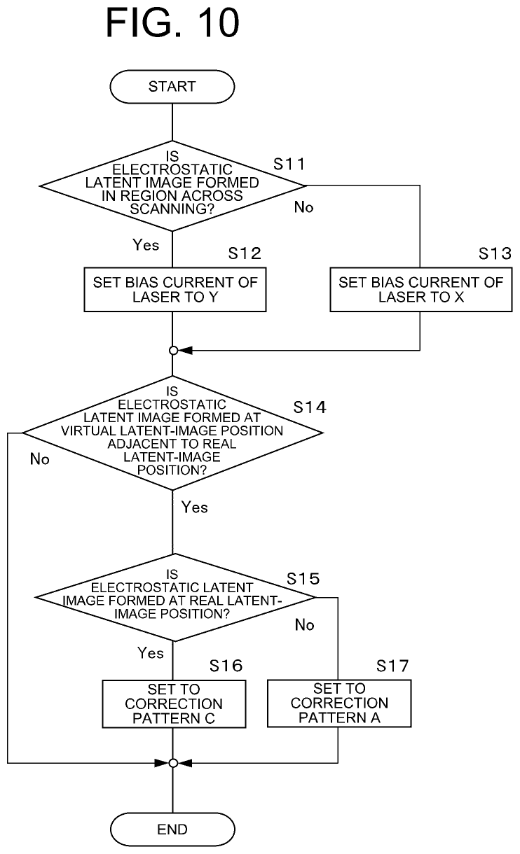

Subsequently, laser correction processing of the digital multifunction machine 1 according to Embodiment 2 of this disclosure will be explained with reference to FIGS. 9A and 9B and FIG. 10.

The configurations of the digital multifunction machine 1 according to Embodiment 2 of this disclosure and the laser correction processing thereof are the same as those of FIG. 2 to FIG. 5 (Embodiment 1) and thus, the explanation thereof will be omitted.

FIGS. 9A and 9B are explanatory diagrams illustrating an example of a real latent-image line and a virtual latent-image line adjacent thereto of image data of the digital multifunction machine 1 according to Embodiment 2 of this disclosure, and a setting example of correction thereof.

FIG. 9A illustrates a setting example of correction in a case where there is no region across scanning and FIG. 9B illustrates a setting example of the correction in a case where there is a region across scanning.

The positions of the real latent-image line and the virtual latent-image line adjacent thereto in the image data in FIGS. 9A and 9B are the same as those in FIGS. 6A and 6B (Embodiment 1), but this Embodiment is different from Embodiment 1 in that the bias current of the semiconductor laser 1104 is also corrected in addition to the PWM DUTY ratio.

Note that, in Embodiment 2, as shown in FIG. 9A and FIG. 9B, depending on the presence/absence of the region across scanning, the set value of the correction of the PWM DUTY ratio is the same, but the value of the bias current of the semiconductor laser 1104 is different.

FIG. 10 is a flowchart illustrating an example of a laser correction processing of the digital multifunction machine 1 according to Embodiment 2 of this disclosure.

At Step S11 of FIG. 10, the controller 100 determines whether or not the electrostatic latent image is formed in the region across scanning (Step S11).

When the electrostatic latent image is formed in the region across scanning (in a case where the determination at Step S11 is Yes), at Step S12, the controller 100 sets the bias current of the semiconductor laser 1104 to Y (Step S12).

On the other hand, when the electrostatic latent image is not formed in the region across scanning (in a case where the determination at Step S11 is No), at Step S13, the controller 100 sets the bias current of the semiconductor laser 1104 to X (Step S13).

In principle, the larger the bias current is, the faster the response of the semiconductor laser 1104 becomes. Therefore, the bias-current set value X of the semiconductor laser 1104 is set to a value larger than Y, for example, X=15 mA and Y=10 mA.

Subsequently, after Step S12 or S13, at Step S14, the controller 100 determines whether or not electrostatic latent image is formed at the virtual latent-image position adjacent to the real latent-image position (Step S14).

When the electrostatic latent image is not formed at the virtual latent-image position adjacent to the real latent-image position (in a case where the determination at Step S14 is No), the controller 100 ends the processing.

On the other hand, when the electrostatic latent image is formed at the virtual latent-image position adjacent to the real latent-image position (in a case where the determination at Step S14 is Yes), at Step S15, the controller 100 determines whether or not the electrostatic latent image is formed at the real latent-image position (Step S15).

When the electrostatic latent image is formed at the real latent-image position (in a case where the determination at Step S15 is Yes), the controller 100 sets the PWM DUTY ratio to the correction pattern C at Step S16 (Step S16) and ends the processing.

On the other hand, when the electrostatic latent image is not formed at the real latent-image position (in a case where the determination at Step S15 is No), at Step S17, the controller 100 sets the PWM DUTY ratio to the correction pattern A (Step S17) and ends the processing.

As described above, when the pseudo high-resolution processing in the sub-scanning direction is executed, it is determined whether or not a virtual latent-image line is formed between two real latent-image lines adjacent to each other in the sub-scanning direction, and on the basis of the determination result, the laser corrector 1105 is caused to correct the PWM DUTY ratio of the plurality of laser beams and the bias current of the semiconductor laser 1104 to appropriately adjust the density of the virtual latent-image line, whereby the digital multifunction machine 1 which is less likely to be affected by reciprocal law failure than before can be realized.

### Embodiment 3

Laser Correction Processing of Digital Multifunction Machine 1 according to Embodiment 3 of this Disclosure

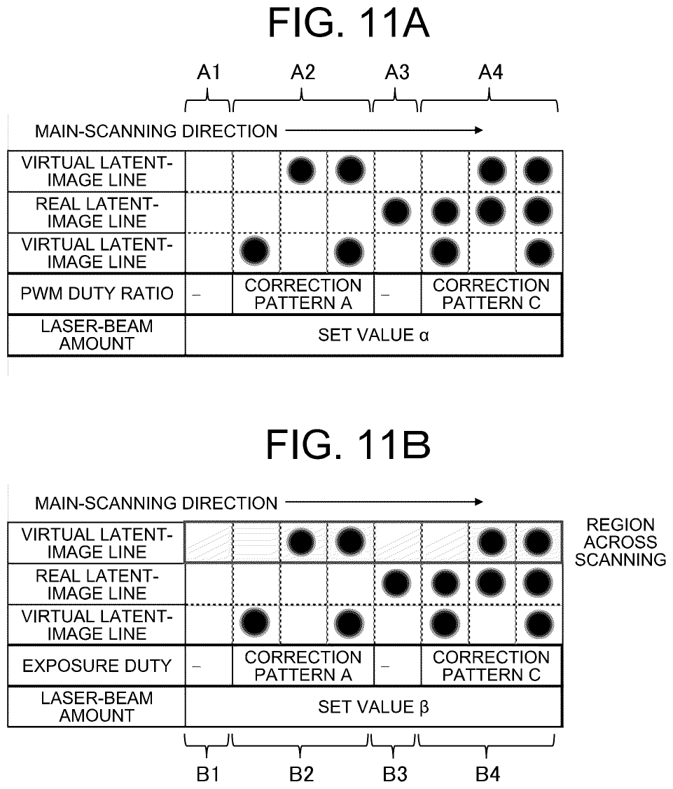

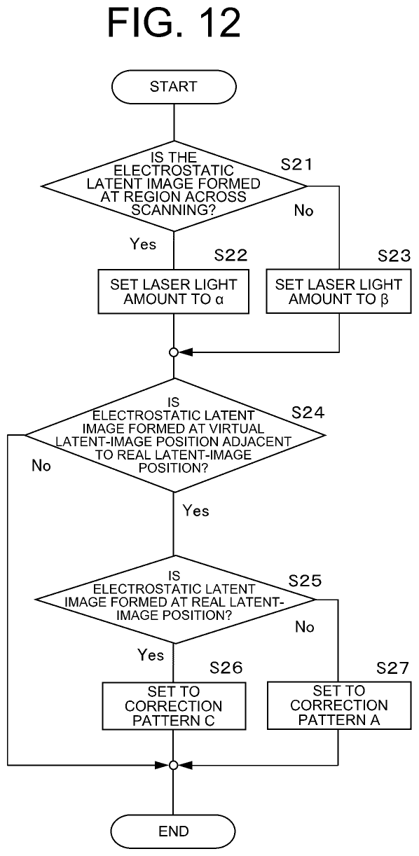

Subsequently, laser correction processing of the digital multifunction machine 1 according to Embodiment 3 of this disclosure will be explained with reference to FIGS. 11A and 11B and FIG. 12.

The configurations of the digital multifunction machine 1 according to Embodiment 3 of this disclosure and the laser correction processing thereof are the same as those of FIG. 2 to FIG. 5 (Embodiment 1) and thus, explanation thereof will be omitted.

FIG. 11 are explanatory diagrams illustrating an example of a real latent-image line and a virtual latent-image line adjacent thereto of image data of the digital multifunction machine 1 according to Embodiment 3 of this disclosure and a setting example of correction thereof. FIG. 11A illustrates a setting example of correction in a case where there is no region across scanning and FIG. 11B illustrates a setting example of the correction in a case where there is a region across scanning.

The positions of the real latent-image lines and the virtual latent-image lines adjacent thereto in the image data in FIGS. 11A and 11B are the same as those in FIGS. 6A and 6B (Embodiment 1) but are different from Embodiment 1 in that the laser-beam amount is also corrected in addition to the PWM DUTY ratio.

Note that, in Embodiment 3, as shown in FIG. 11A and FIG. 11B, the set value of the correction of the PWM DUTY ratio is the same depending on the presence/absence of the region across scanning but the light amount of the laser is different.

FIG. 12 is a flowchart illustrating an example of the laser correction processing of the digital multifunction machine 1 according to Embodiment 3 of this disclosure.

At Step S21 of FIG. 12, the controller 100 determines whether or not electrostatic latent image is formed in the region across scanning (Step S21).

When the electrostatic latent image is formed in the region across scanning (in a case where the determination at Step S21 is Yes), at Step S22, the controller 100 sets the laser-beam amount to α (Step S22).

On the other hand, when the electrostatic latent image is not formed in the region across scanning (in a case where the determination at Step S11 is No), at Step S23, the controller 100 sets the laser-beam amount to β (Step S23).

Note that the set value α of the laser-beam amount is set to a value larger than β such as, for example, α=140 μW and β=120 μW.

Subsequently, after Step S22 or S23, at Step S24, the controller 100 determines whether or not electrostatic latent image is are formed at the virtual latent-image position adjacent to the real latent-image position (Step S24).

When the electrostatic latent image is not formed at the virtual latent-image position adjacent to the real latent-image position (in a case where the determination at Step S24 is No), the controller 100 ends the processing.

On the other hand, when the electrostatic latent image is formed at the virtual latent-image position adjacent to the real latent-image position (in a case where the determination at Step S24 is Yes), at Step S25, the controller 100 determines whether or not the electrostatic latent image is formed at the real latent-image position (Step S25).

When the electrostatic latent image is formed at the real latent-image position (in a case where the determination at Step S25 is Yes), at Step S26, the controller 100 sets the PWM DUTY ratio to the correction pattern C (Step S26) and ends the processing.

On the other hand, when the electrostatic latent image is not formed at the real latent-image position (in a case where the determination at Step S25 is No), at Step S27, the controller 100 sets the PWM DUTY ratio to the correction pattern A (Step S27) and ends the processing.

As described above, when the pseudo high-resolution processing in the sub-scanning direction is executed, it is determined whether or not a virtual latent-image line is formed between two real latent-image lines adjacent to each other in the sub-scanning direction, and on the basis of the determination result, the laser corrector 1105 is caused to correct the PWM DUTY ratio and the laser-beam amount of a plurality of laser beams to appropriately adjust the density of the virtual latent-image line, whereby the digital multifunction machine 1 which is less likely to be affected by reciprocal law failure than before can be realized.

A preferred form of this disclosure includes a combination of any of the forms described above. In addition, in Embodiments 1 to 3 of this disclosure, the case where the region across scanning is on the upper side of the real latent-image line was exemplified, but the region across scanning may be on the lower side of the real latent-image line.

There can be various modifications to this disclosure in addition to Embodiments described above. Those modifications should not be construed as falling outside the scope of this disclosure. This disclosure should embrace the claims and their equivalents and all modifications within the scope of the claims.

What is claimed is:

1. An image forming apparatus, comprising:
an image-data acquirer that acquires image data;
a photoreceptor;
a charger that charges the photoreceptor;
an exposure section that forms an electrostatic latent image on the photoreceptor in a charged state;
a developer that supplies a toner to the photoreceptor and forms a toner image corresponding to the electrostatic latent image;
a transferer that transfers the toner image to a print sheet;
an image former including a fixer that heats and fixes the toner image to the print sheet; and
one or more controllers that control the image-data acquirer, the photoreceptor, the charger, the exposure section, the developer, the transferer and the image former,
the exposure section including:
a plurality of laser light-sources that emit a plurality of laser beams;
a polygon mirror that deflects the plurality of laser beams by a plurality of mirror surfaces and emits the same to a scanning region of the photoreceptor;
a laser driver that forms the electrostatic latent image by irradiating the scanning region of the photoreceptor in the charged state with the plurality of laser beams on the basis of the image data acquired by the image-data acquirer; and
a laser corrector that corrects the laser beam, wherein
the one or more controllers control the exposure section such that a real latent-image line is formed by irradiating the scanning region of the photoreceptor with the plurality of laser beams in a main-scanning direction, determine whether or not a virtual latent-image line is formed between two pieces of the real latent-image lines adjacent to each other in a sub-scanning direction, and cause the laser corrector to correct the plurality of laser beams and adjust density of the virtual latent-image line on the basis of a determination result.

2. The image forming apparatus according to claim 1, wherein, when a virtual latent-image line is formed, the one or more controllers determine whether or not the virtual latent-image line is formed in a region across scanning between a scanning region of the photoreceptor by the one mirror surface of the polygon mirror and a scanning region of the photoreceptor by the subsequent mirror surface, and when the virtual latent-image line is formed in the region across scanning, the one or more controllers cause the laser corrector to correct the plurality of laser beams so as to lower the density of the virtual latent-image line than a case where the virtual latent-image line is formed without changing the mirror surface of the polygon mirror.

3. The image forming apparatus according to claim 2, wherein, when the virtual latent-image line is formed in the region across scanning, the one or more controllers determine whether or not the real latent-image line is formed at a real latent-image position adjacent to the virtual latent-image line, and when the real latent-image line is formed at the real latent-image position, cause the laser corrector to correct the plurality of laser beams so as to lower the density of the virtual latent-image line than a case where the real latent-image line is not formed at the real latent-image position.

4. The image forming apparatus according to claim 1, wherein the laser corrector adjusts the density of the virtual latent-image line by correcting at least one of a PWM DUTY ratio of the plurality of laser beams, a bias current of the plurality of laser light sources, and light amounts of the plurality of laser beams.
